(19) United States
(12) Patent Application Publication
(10) Pub. No.: US 2023/0211731 A1
(43) Pub. Date: Jul. 6, 2023

(54) VEHICLE MIRROR SELECTION BASED ON HEAD POSE AND GAZE DIRECTION

(71) Applicant: GM Global Technology Operations LLC, Detroit, MI (US)

(72) Inventors: Francis Edward Szczublewski, Bloomfield Township, MI (US); Sainath Varanasi, Sterling Heights, MI (US); Premendra Kumar, Troy, MI (US)

(21) Appl. No.: 17/568,946

(22) Filed: Jan. 5, 2022

(51) Int. Cl. B60R 1/064; B60K 35/00

(52) U.S. Cl. CPC B60R 1/064; B60K 35/00; B60K 2370/21

(57) ABSTRACT

A system in a vehicle includes processing circuitry to identify a selected side mirror by determining whether a driver is looking at a first side mirror or a second side mirror based on head pose or gaze direction detection. The system also includes an interface to control adjustment of a position of the selected side mirror based on driver input.

### INTRODUCTION

The subject disclosure relates to vehicle mirror selection based on head pose and gaze direction.

In a vehicle (e.g., automobile, truck, construction equipment, farm equipment), the rearview and side mirrors increase the field of view of the driver and facilitate avoiding collisions. The side mirrors can prevent a lane change into traffic, for example. However, when a different driver enters a vehicle or a driver changes a previous seating position, adjustment of the mirrors to provide the correct view is essential to maximizing the utility of the mirrors. Accordingly, it is desirable to provide vehicle mirror selection based on head pose and gaze direction.

### SUMMARY

In one exemplary embodiment, a system in a vehicle includes processing circuitry to identify a selected side mirror by determining whether a driver is looking at a first side mirror or a second side mirror based on head pose or gaze direction detection. The system also includes an interface to control adjustment of a position of the selected side mirror based on driver input.

In addition to one or more of the features described herein, the processing circuitry identifies the selected side mirror in response to obtaining the driver input.

In addition to one or more of the features described herein, the driver input is an operation of a directional control button.

In addition to one or more of the features described herein, the directional control button is one of a plurality of directional control buttons to control the adjustment of the position of the selected side mirror.

In addition to one or more of the features described herein, the driver input is an operation of a joystick.

In addition to one or more of the features described herein, the processing circuitry identifies the selected side mirror using one or more cameras directed at a face of the driver.

In addition to one or more of the features described herein, the processing circuitry iteratively identifies the selected side mirror and controls the adjustment of the position of the selected side mirror for each driver input.

In addition to one or more of the features described herein, the interface provides a control signal to the selected side mirror based on the driver input to control the adjustment of the position of the selected side mirror.

In another exemplary embodiment, a method in a vehicle includes configuring processing circuitry to identify a selected side mirror by determining whether a driver is looking at a first side mirror or a second side mirror based on head pose or gaze direction detection. The method also includes configuring an interface to control adjustment of a position of the selected side mirror based on driver input.

In addition to one or more of the features described herein, the configuring the processing circuitry includes the processing circuitry identifying the selected side mirror in response to obtaining the driver input.

In addition to one or more of the features described herein, the driver input is an operation of a directional control button.

In addition to one or more of the features described herein, the directional control button is one of a plurality of directional control buttons to control the adjustment of the position of the selected side mirror.

In addition to one or more of the features described herein, the driver input is an operation of a joystick.

In addition to one or more of the features described herein, the configuring the processing circuitry includes the processing circuitry identifying the selected side mirror using one or more cameras directed at a face of the driver.

In addition to one or more of the features described herein, the configuring the processing circuitry includes the processing circuitry iteratively identifying the selected side mirror and controlling the adjustment of the position of the selected side mirror for each driver input.

In addition to one or more of the features described herein, the configuring the interface includes the interface providing a control signal to the selected side mirror based on the driver input to control the adjustment of the position of the selected side mirror.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows aspects of a vehicle that includes vehicle mirror selection based on head pose and gaze direction; and

FIG. 2 is a process flow of a method of performing vehicle mirror selection based on head pose and gaze direction according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, the rearview mirror and side mirrors can expand the field of view of a driver and thereby improve safety. As also noted, the mirrors must be adjusted for each driver and each driving position in order to maximize their utility. Adjusting the position of a rearview mirror is straight-forward, because a driver can simply reach up and make a manual adjustment but adjusting the side mirrors is less simple due to their placement on the exterior of the vehicle and the distance of one of the side mirrors from the driver. Electrically adjustable side mirrors, referred to as power mirrors, addressed this inconvenience by allowing adjustment of the side mirror positions with directional control buttons. Prior power side mirrors additionally include a power mirror switch that allows selection of one of the side mirrors so that only the selected mirror is moved based on pressing the directional control buttons. This adds an expense to the mirror adjustment mechanism that is associated with an additional button and associated wiring.

Embodiments of the systems and methods detailed herein relate to vehicle mirror selection based on head pose and gaze direction. Many vehicles include one or more cameras to track the head pose, indicating the direction that a face is turned, and gaze direction, indicating a direction in which one or both eyes of the driver are focused. The images may be used to determine driver alertness, for example. That is, the head pose and gaze direction, alone or in conjunction with other sensor information, may indicate whether the driver has fallen asleep (e.g., eyes are closed) or is distracted (e.g., head and eyes looking down), for example. The determination may result in an alert being issued to the driver, for example. The side mirror selection, according to one or more embodiments, takes advantage of the availability of the head pose and gaze direction in the vehicle to eliminate the mirror selection button.

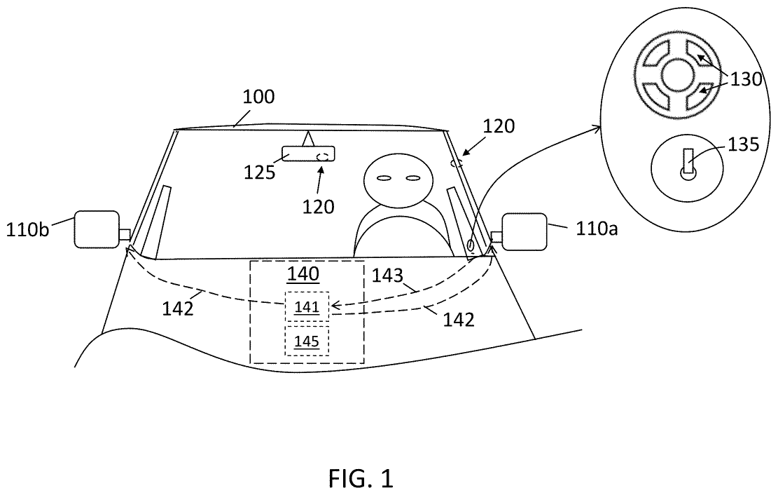

In accordance with an exemplary embodiment, FIG. 1 shows aspects of a vehicle 100 that includes vehicle mirror selection based on head pose and gaze direction. The vehicle 100 is shown with side mirrors 110a, 110b (generally referred to as 110), a rear-view mirror 125, directional control buttons 130, and a controller 140. A driver is shown on one side of the vehicle 100 such that the side mirror 110a is the driver-side mirror. However, in a different vehicle, the driver may be seated on the opposite side such that the side mirror 110b is the driver-side mirror. An exemplary camera 120 is shown in the rear-view mirror 125. Another exemplary camera 120 is shown in a side pillar of the vehicle 100. One or more additional or alternate cameras 120 may be positioned in different areas, and the one or more cameras 120 may be directed to the face of the driver to facilitate head pose and/or gaze direction detection.

Four exemplary directional control buttons 130 or a joystick 135 are shown located on an armrest of a vehicle door panel. The four directional control buttons 130 or joystick 135 may facilitate providing input 143 to move a selected one of the side mirrors 110 up or down and to one side or the other. According to alternate embodiments, additional directional control buttons 130 (i.e., providing more than four directions for movement of the side mirrors 110) may be provided and may be located elsewhere within the vehicle 100. In addition, functionality of the directional control buttons 130 may be included in an infotainment system of the vehicle 100 via a touchscreen, for example. The controller 140 may perform the head pose and/or gaze direction determination and control the selected side mirror 110 according to the input 143 via operation of the directional control buttons 130 or joystick 135. The controller 140 may additionally control aspects of vehicle operation.

The controller 140 may include processing circuitry 145 that may include an application specific integrated circuit (ASIC), an electronic circuit, a processor (shared, dedicated, or group) and memory that executes one or more software or firmware programs, a combinational logic circuit, and/or other suitable components that provide the described functionality. As shown, the controller 140 includes an interface 141 to receive input 143 based on operation of the directional control buttons 130 or joystick 135. The processing circuitry 145 may determine which of the side mirrors 110 is selected for adjustment using head pose and/or gaze direction, according to one or more embodiments. Then, the interface 141 may send a control signal 142, directly or via additional processors, to the selected side mirror 110 to implement a position change based on the input 143. The interface 141 may include wiring or wireless communication according to alternate embodiments.

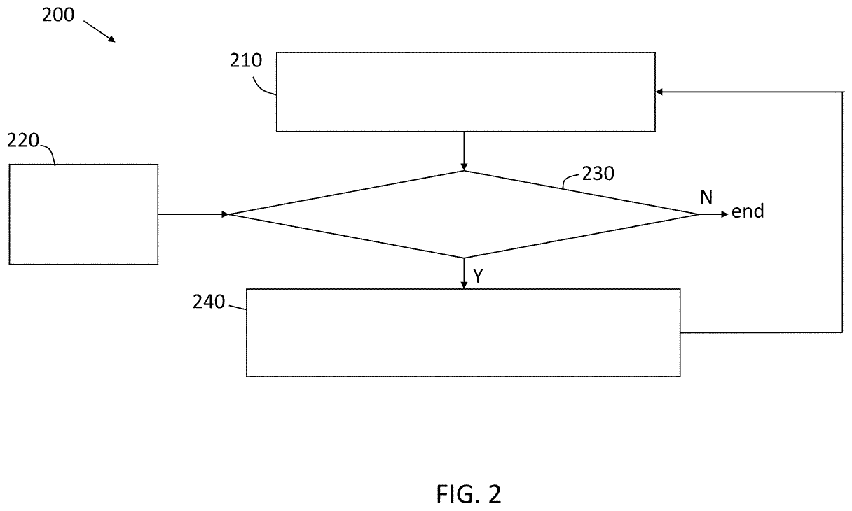

FIG. 2 is a process flow of a method 200 of performing vehicle mirror selection based on head pose and gaze direction according to one or more embodiments. The processes may be performed by the controller 140. At block 210, receiving input at one of the directional control buttons 130 or via the joystick 135 is a trigger for the method 200. At block 220, head pose and/or eye gaze detection are performed. These processes may be performed continually for different purposes such as driver alertness monitoring, as previously noted.

Specifically, one or more cameras 120 may be used, according to known processes, to detect the position of the driver's head and/or the direction in which the eyes are looking. When both head pose and gaze direction are obtained, the combination of the head pose and eye gaze may be used to ascertain what the driver is looking at. A trained machine learning algorithm or other known approach may be used to determine where the driver is looking based on head pose and/or gaze direction.

At block 230, a check is done of whether the driver is looking at one of the side mirrors 110. As FIG. 2 indicates, this check is only performed after an input is received from one of the directional control buttons 130 or via the joystick 135. Thus, the driver's looking at one of the side mirrors 110 alone would not result in any adjustments. If the check at block 230 indicates that the driver is not looking at one of the side mirrors 110, then the processes end until the driver operates one of the directional control buttons 130 or the joystick 135 again to trigger the method 200. Thus, accidental operation of a directional control button 130 or the joystick 135 would not result in any adjustments.

If the check at block 230 indicates that the driver is looking at one of the side mirrors 110, then, at block 240, the input received via the directional control button 130 or the joystick 135 is applied to the side mirror 110 at which the driver is looking. For example, if the driver presses the “up” directional control button 130 or pushes the joystick 135 up while looking at the side mirror 110b, then the press of the “up” directional control button 130 or push of the joystick 135 would serve as the trigger at block 210, the check at block 230 would confirm that that the driver was looking at the side mirror 110b, and, thus, the side mirror 110b would be controlled to move up from its current position, at block 240.

As FIG. 2 indicates, the processes are iterative. Thus, as long as the driver keeps providing an input via one of the directional control buttons 130 or the joystick 135 to provide the trigger at block 210 and as long as the driver keeps looking at one of the side mirrors 110 to pass the check at block 230, the side mirror 110 indicated by the check at block 230 will be adjusted, at block 240, according to the input via the directional control button 130 or joystick 135. As previously noted, applying the directional control button 130 or joystick 135 input, at block 240, to adjust the selected side mirror 110 may include the controller 140 sending a control signal 142 from an interface 141 to the selected side mirror 110.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system in a vehicle, the system comprising:
processing circuitry configured to identify a selected side mirror by determining whether a driver is looking at a first side mirror or a second side mirror based on head pose or gaze direction detection; and
an interface configured to control adjustment of a position of the selected side mirror based on driver input.

2. The system according to claim 1, wherein the processing circuitry is configured to identify the selected side mirror in response to obtaining the driver input.

3. The system according to claim 2, wherein the driver input is an operation of a directional control button.

4. The system according to claim 3, wherein the directional control button is one of a plurality of directional control buttons configured to control the adjustment of the position of the selected side mirror.

5. The system according to claim 2, wherein the driver input is an operation of a joystick.

6. The system according to claim 1, wherein the processing circuitry is configured to identify the selected side mirror using one or more cameras directed at a face of the driver.

7. The system according to claim 1, wherein the processing circuitry is configured to iteratively identify the selected side mirror and to control the adjustment of the position of the selected side mirror for each driver input.

8. The system according to claim 1, wherein the interface is configured to provide a control signal to the selected side mirror based on the driver input to control the adjustment of the position of the selected side mirror.

9. A method in a vehicle, the method comprising:
configuring processing circuitry to identify a selected side mirror by determining whether a driver is looking at a first side mirror or a second side mirror based on head pose or gaze direction detection; and
configuring an interface to control adjustment of a position of the selected side mirror based on driver input.

10. The method according to claim 9, wherein the configuring the processing circuitry includes the processing circuitry identifying the selected side mirror in response to obtaining the driver input.

11. The method according to claim 10, wherein the driver input is an operation of a directional control button.

12. The method according to claim 11, wherein the directional control button is one of a plurality of directional control buttons configured to control the adjustment of the position of the selected side mirror.

13. The method according to claim 10, wherein the driver input is an operation of a joystick.

14. The method according to claim 9, wherein the configuring the processing circuitry includes the processing circuitry identifying the selected side mirror using one or more cameras directed at a face of the driver.

15. The method according to claim 9, wherein the configuring the processing circuitry includes the processing circuitry iteratively identifying the selected side mirror and controlling the adjustment of the position of the selected side mirror for each driver input.

16. The method according to claim 9, wherein the configuring the interface includes the interface providing a control signal to the selected side mirror based on the driver input to control the adjustment of the position of the selected side mirror.
